(19) United States
(12) Patent Application Publication
(10) Pub. No.: US 2026/0175746 A1
(43) Pub. Date: Jun. 25, 2026

(54) SEATING SYSTEM

(71) Applicant: Faurecia Automotive Seating, LLC, Auburn Hills, MI (US)

(72) Inventor: Robert C. FITZPATRICK, Auburn Hills, MI (US)

(21) Appl. No.: 18/990,345

(22) Filed: Dec. 20, 2024

(51) Int. Cl. B60N 2/10; B60N 2/16; B60N 2/90

(52) U.S. Cl. CPC B60N 2/10; B60N 2/1665; B60N 2/914

(57) ABSTRACT

A seat of a seating row comprises a seat bottom including a bottom cushion having a bottom support and a bottom support changer. The seat comprises a seat back coupled to the seat bottom and including a back cushion having a back support and a back support changer. The back support changer and the bottom support changer move the back support and the bottom support, respectively, between a raised position in a flat configuration and a lowered position in a contour configuration

### BACKGROUND

The present disclosure relates to a vehicle seat, and particularly to a vehicle seating row having a first seat coupled to a second seat.

### SUMMARY

According to the present disclosure, a seating row for a vehicle includes a first seat and a second seat. The first seat is coupled to a floor of the vehicle, and the second seat is coupled to the floor of the vehicle and to the first seat. Each of the first seat and the second seat include a seat bottom and a seat back. The seat bottom includes a foundation coupled to the floor of the vehicle and a bottom pad coupled to the foundation. The bottom pad includes a bottom cushion having a bottom support and a bottom support changer. The seat back is coupled to the seat bottom. The seat back includes a headrest spaced above the seat bottom, a backrest located between the headrest and the seat bottom, and a back pad coupled to the backrest. The back pad includes a back cushion having a back support and a back support changer.

The seating row includes an inner bolster disposed between the first seat and the second seat, a first outer bolster disposed along a side of the first seat, opposite from the inner bolster, and a second outer bolster disposed along a side of the second seat, opposite from the inner bolster. The back support changer and the bottom support changer move the back support and the bottom support, respectively, between a raised position in a flat configuration and a lowered position in a contour configuration.

In illustrative embodiments, in the flat configuration, the bottom supports provide support to the seat bottom such that an upper surface of the seat bottom is flat.

In illustrative embodiments, in the flat configuration, the back support provides support to the seat back such that a forward surface of the seat back is flat.

In illustrative embodiments, in the contour configuration, the lowered position of at least one of the bottom support or the back support forms a recessed area in the seating row. In the contour configuration, the inner bolster may divide a respective recessed area of the first seat and the second seat.

In illustrative embodiments, at least one of the bottom support or the back support comprises a bladder, the bladder pneumatically controlled to move between the raised position and the lowered position.

In illustrative embodiments, at least one of the bottom support or the back support comprises at least one strap. The at least one strap may be taut in the flat configuration and the at least one strap may be slack in the contour configuration to allow a recessed area to be formed in the seating row. The at least one strap may extend from a rear portion of the seat bottom to a front portion of the seat bottom beneath an upper surface of the seat bottom. The at least one strap may extend from a lower portion of the seat back to an upper portion of the seat back beneath a forward surface of the seat back.

In illustrative embodiments, at least one of the bottom support changer or the back support changer comprises a tensioning device configured to loosen or tighten the at least one strap. The tensioning device may be disposed in a rear portion of the bottom cushion. The tensioning device may be disposed in a lower portion of the back cushion.

In illustrative embodiments, in the contour configuration, a first portion of an upper surface of the seat bottom above the bottom support sits below a second portion of the upper surface of the seat bottom at the inner bolster.

In illustrative embodiments, at least one of the bottom support or the back support comprises a compressible material. The compressible material may be at least partially expanded in the flat configuration when no external weight is applied to the seating row. The compressible material may be at least partially compressed in the contour configuration to form a recessed area when an external weight is applied to the seating row.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a diagrammatic and perspective view of a seating row of a vehicle, showing the seating row includes a first seat coupled to a second seat, each seat having a seat bottom and a seat back including a respective support and support changer that moves the support between a raised position in a flat configuration and a lowered position in a contour configuration.

FIG. 2 shows the seating row of FIG. 1 arranged in the flat configuration, with the bottom supports and back supports positioned in the raised position such that an upper surface of the seat bottom and a forward surface of the seat back are substantially flat.

FIG. 3 shows the seating row of FIG. 1 arranged in the contour configuration, with the bottom supports and back supports positioned in the lowered position such that they form a first and second recessed portion of the seating row.

FIG. 4 shows the seating row of FIG. 1, showing an internal view of the bottom supports and back supports disposed in the seat back and seat bottom of the first and second seats.

FIG. 5 shows a cross-sectional view of one of the seats in the seating row of FIG. 4, taken along the section line 5-5 in FIG. 4, showing the bottom support in the raised position of the flat configuration.

FIG. 6 shows a cross-sectional view of one of the seats in the seating row of FIG. 4, taken along the section line 5-5 in FIG. 4, showing the bottom support in the lowered position of the contour configuration.

FIG. 7A shows a cross-sectional view of the seating row of FIG. 4 taken along the section line 7-7 in FIG. 4, showing an embodiment of the supports comprises a plurality of straps and an embodiment of the support changers comprises a tensioning device capable of tightening or loosening the plurality of straps between the raised and lowered position.

FIG. 7B shows a cross-sectional view of the seating row of FIG. 7A taken along the section line 7-7 in FIG. 4, showing the seating row in the flat configuration with the plurality of straps of the supports in the raised position, pulled taut by the tensioning device.

FIG. 7C shows a cross-sectional view of the seating row of FIG. 7A taken along the section line 7-7 in FIG. 4, showing the seating row in the contour configuration with the plurality of straps of the supports in the lowered position, loosened by the tensioning device.

FIG. 8A shows a cross-sectional view of the seating row of FIG. 4 taken along the section line 7-7 in FIG. 4, showing an embodiment of the supports comprises a bladder and an embodiment of the support changer comprises a pneumatic device capable of inflating or deflating the bladder between the raised and lowered position.

FIG. 8B shows a cross-sectional view of the seating row of FIG. 8A taken along the section line 7-7 in FIG. 4, showing the seating row in the flat configuration with the bladders in the raised position, inflated by the pneumatic device.

FIG. 8C shows a cross-sectional view of the seating row of FIG. 8A taken along the section line 7-7 in FIG. 4, showing the seating row in the contour configuration with the bladders in the lowered position, at least partially deflated by the pneumatic device.

FIG. 9A shows a cross-sectional view of the seating row of FIG. 4 taken along the section line 7-7 in FIG. 4, showing an embodiment of the support comprises a compressible material capable of compressing or expanding between the raised and lowered position.

FIG. 9B shows a cross-sectional view of the seating row of FIG. 9A taken along the section line 7-7 in FIG. 4, showing the seating row in the flat configuration with the compressible material of the supports expanded to be in the raised position.

FIG. 9C shows a cross-sectional view of the seating row of FIG. 9A taken along the section line 7-7 in FIG. 4, showing the seating row in the contour configuration with the compressible material of the supports in the lowered position, at least partially compressed by a weight of an occupant.

### DETAILED DESCRIPTION

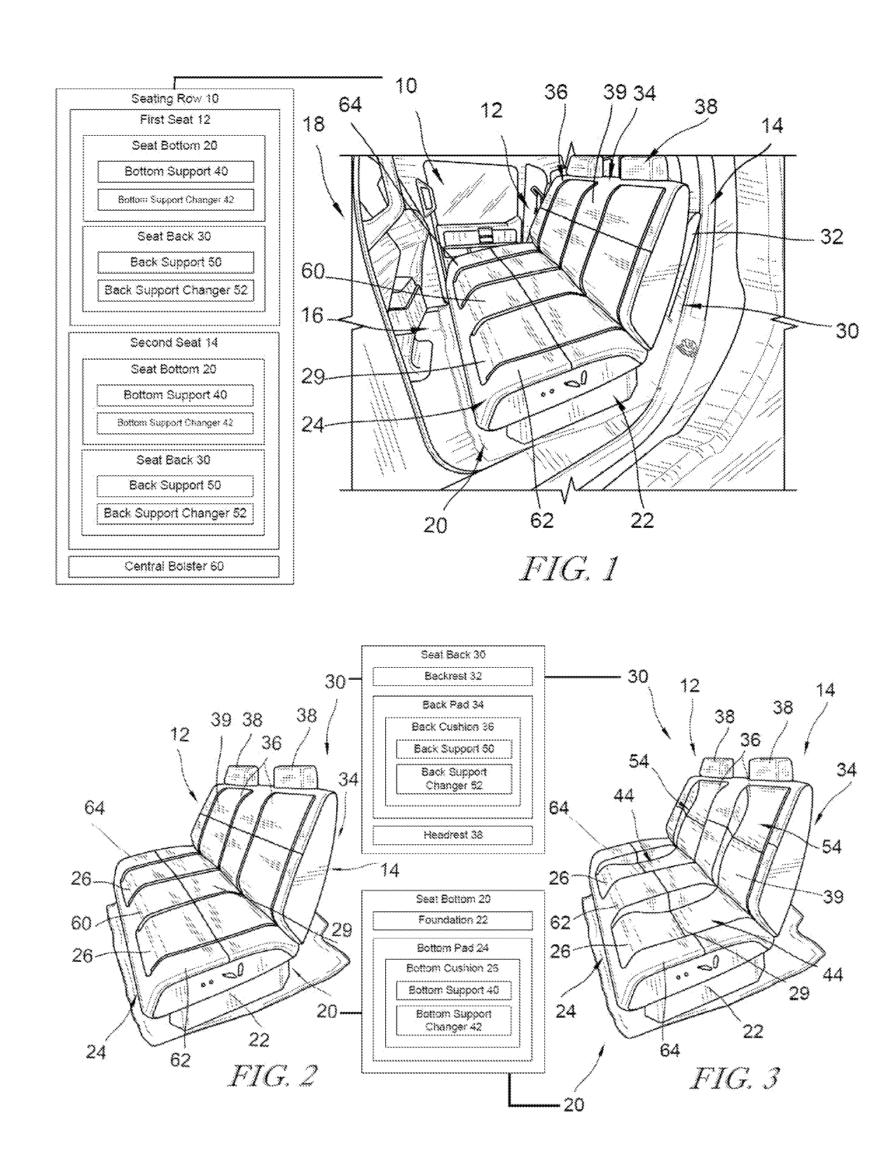

A vehicle seating row 10 includes a first seat 12 and a second seat 14. The seating row 10 may also be referred to as an occupant support 10 and/or a bench seat. Each of the first 12 and second seats 14 include a respective seat bottom 20 and a respective seat back 30. The seat bottom 20 includes a foundation 22 adapted to be anchored to a vehicle floor 16 and a bottom pad 24 mounted on foundation 22. The seat back 30 is arranged to extend upwardly away from that seat bottom 20 as suggested in FIG. 1 and includes a backrest 32 and a back pad 34 mounted on the backrest 32.

As shown in FIGS. 1-3, the bottom pad 24 includes a bottom cushion 26 comprising a bottom support 40 to support an occupant and a bottom support changer 42 to move the bottom support 40 between a raised position and a lowered position. The back pad 34 includes a back cushion 36 comprising a back support 50 to support an occupant and a back support changer 52 to move the back support 50 between a raised position and a lowered position. The seating row 10 is configurable between a flat configuration, and shown in FIG. 2, and a contour configuration, as shown in FIG. 3, by moving the supports 40, 50 between the raised and lowered positions

In the flat configuration, the support changer 42, 52 moves the respective support 40, 50 to be positioned in the raised position. In the raised position, the bottom support 40 provides support to the seat bottoms 20 such that an upper surface 29 of the seat bottoms 20 is substantially flat. Additionally or alternatively, in the raised position, the back support 50 provides support to the seat back 30 such that a forward surface 39 of the seat back 30 is substantially flat.

In the contour configuration, the support changer 42, 52 moves the respective support 40, 50 to be positioned in the lowered position. In the lowered position, the lowered bottom support 40 forms a bottom recessed area 44 in the seat bottom 20. Additionally or alternatively, in the lowered position, the lowered back support 50 forms a back recessed area 54 in the seat back 30. In the illustrative embodiments, the inner bolster 60 divides the respective recessed areas 44, 54 of the first seat 12 and the second seat 14. In the illustrative embodiment, the recessed areas 44, 54 of the respective seats 12, 14 may be shaped to form a bucket seat.

Turning back to FIG. 1, the seat bottom 20 and the seat back 30 cooperate to define an occupant-support region 18 adapted to support an occupant above vehicle floor 16. The bottom pad 24 of the seat bottom 20 is coupled to the foundation 22 and is spaced apart from vehicle floor 16, while the seat back 30 is coupled to seat bottom 20 and is arranged to extend upwardly from seat bottom 20 and the foundation 22.

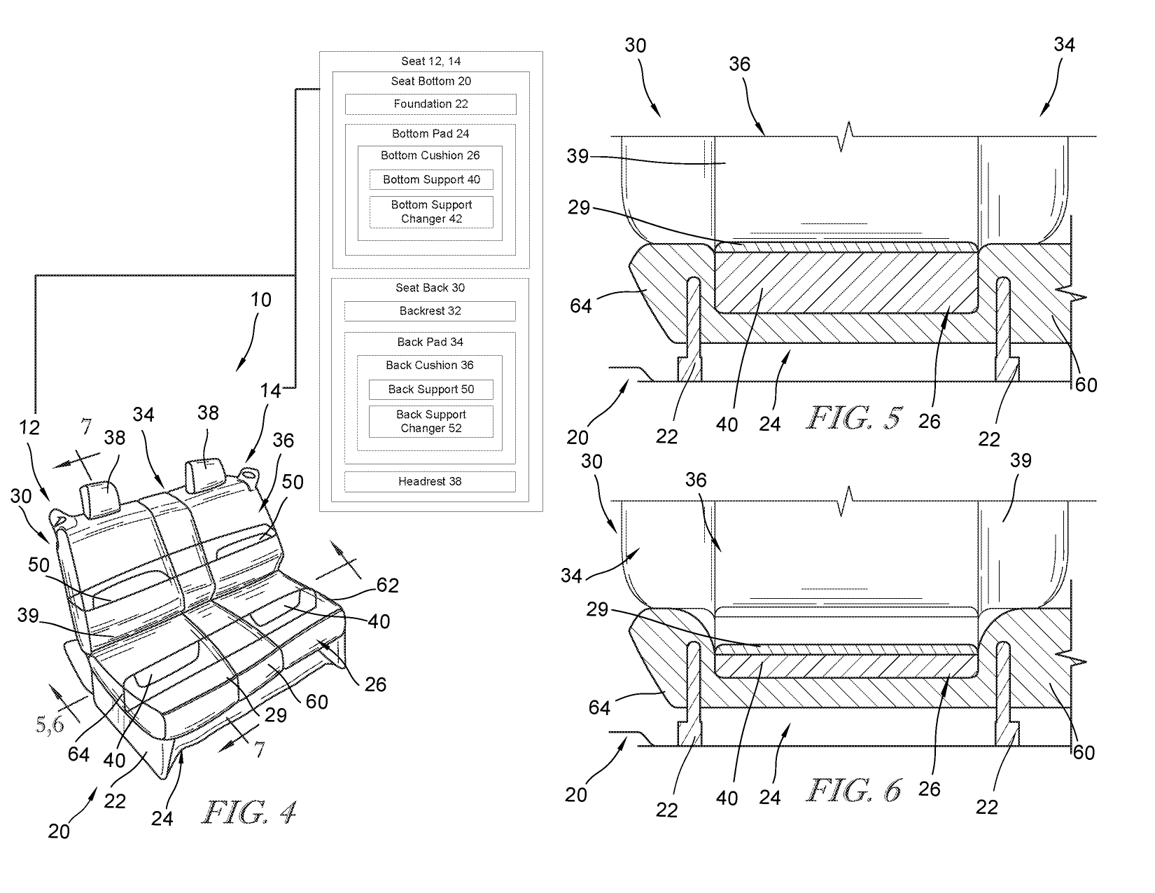

The seat bottom 20 includes the bottom pad 24 and a bottom cushion 26 as shown illustratively in FIG. 1 and diagrammatically in FIGS. 2-4. The bottom pad 24 comprises a bottom cushion 26, which includes a bottom support 40 to support an occupant and a bottom support changer 42 to move the bottom support 40 between a raised position and a lowered position.

In the illustrative embodiments, the seat back 30 includes a headrest 38, a backrest 32 disposed between the seat bottom 20 and the headrest 38, and a back pad 34 coupled to the backrest 32, as shown illustratively in FIG. 1 and diagrammatically in FIGS. 2-3. The back pad 34 comprises a back cushion 36, which includes a back support 50 to support an occupant and a back support changer 52 to move the back support 50 between a raised position and a lowered position.

The seating row 10 is configurable between a flat configuration, and shown in FIG. 2, and a contour configuration, as shown in FIG. 3, by moving the supports 40, 50 between the raised and lowered positions. In the flat configuration, the support changer 42, 52 moves the respective support 40, 50 to be positioned in the raised position. In the raised position, the bottom support 40 provides support to the seat bottoms 20 such that an upper surface 29 of the seat bottoms 20 is substantially flat. Additionally or alternatively, in the raised position, the back support 50 provides support to the seat back 30 such that an forward surface 39 of the seat back 30 is substantially flat, forming a uniformly flat blench seat extending across the seating row 10.

In the contour configuration, the support changer 42, 52 moves the respective support 40, 50 to be positioned in the lowered position. In the lowered position, the lowered bottom support 40 forms a bottom recessed area 44 in the seat bottom 20. Additionally or alternatively, in the lowered position, the lowered back support 50 forms a back recessed area 54 in the seat back 30. In the illustrative embodiments, the inner bolster 60 divides the respective recessed areas 44, 54 of the first seat 12 and the second seat 14, transforming the first and second seats 12, 14 into bucket seats.

In some embodiments, the support changers 42, 52 of the first and second seats 12, 14 may be independently actuated such that the first seat 12 may be in the contour configuration with the supports 40, 50 of the first seat 12 in the lowered position, while the second seat 14 may be in the flat configuration with the supports 40, 50 of the second seat 14 in the raised position, or vice versa. In some embodiments, the first and second seats 12, 14 may both be in the same configuration. In some embodiments, the bottom support changers 42 and the back support changers 52 may be independently actuated such that a bottom support 40 may be in the contour configuration with the supports 40 of the first in the lowered position, while the back support 50 of the corresponding seat 12, 14 may be in the flat configuration with the supports 50 in the raised position, or vice versa. In some embodiments, the bottom support 40 and the back support 50 of a respective seat may be in the same configuration.

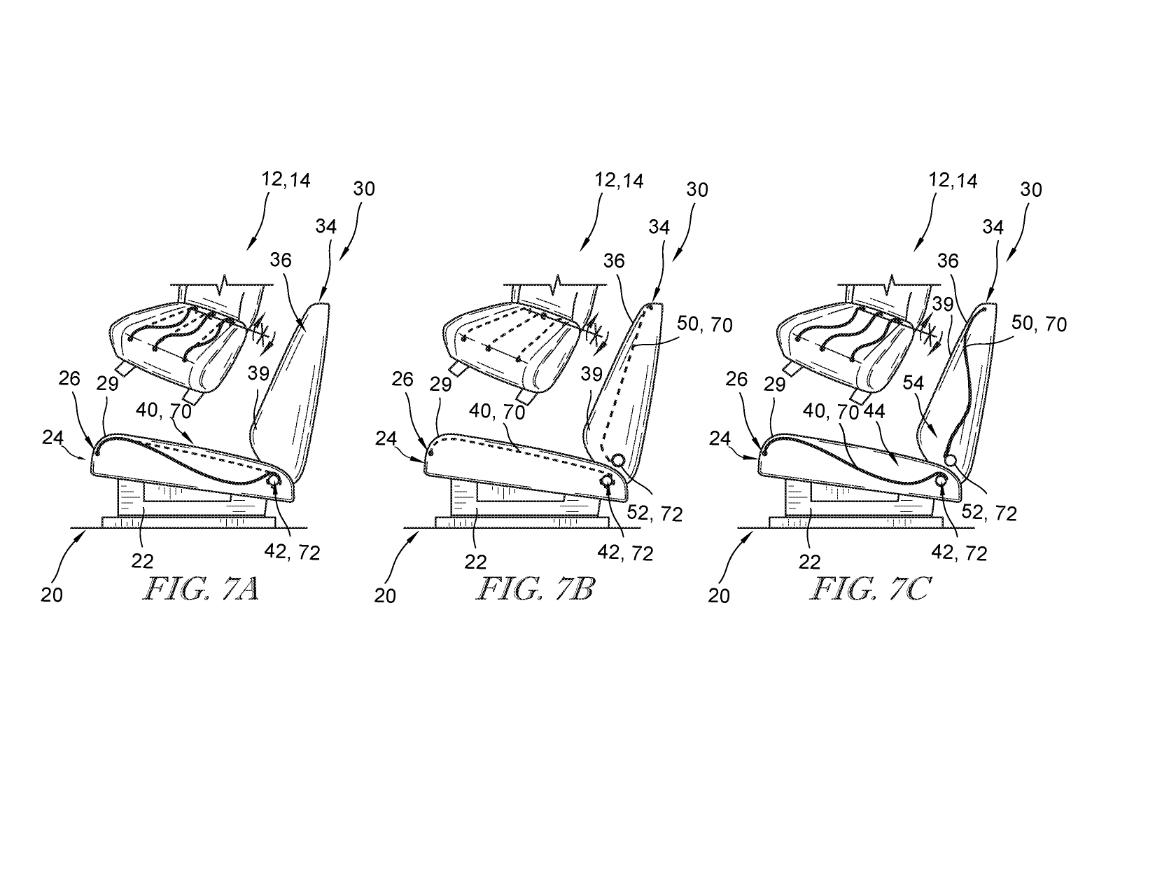

In some embodiments, at least one the supports 40, 50 is moveable between the raised and lowered positions by adjusting a tension of the support 40, 50. For example, in some embodiments, as shown in FIGS. 7A-7C, at least one of the supports 40, 50 includes one or more straps 70. In the illustrative embodiments, the straps 70 extend from a rear portion of the seat bottom 20 to a front portion of the seat bottom 20, beneath the upper surface 29. In some embodiments, the straps 70 extend from a bottom portion of the seat back 30 to an upper portion of the seat back 30, beneath the forward surface 39.

In some embodiments, the support changer 42, 52 includes a tensioning device 72 operable to adjust the tension of the support 40, 50, such as a motor, winch, or other suitable device. In the illustrative embodiment, the tensioning device 72 is disposed in a rear portion of the seat bottom 20 and/or a lower portion of the seat back 30. In some embodiments, the back support 50 and the bottom support 40 of a respective seat 12, 14 utilize the same tensioning device 72. In the illustrative embodiments, the tensioning device 72 of the seat bottom 20 disposed at a rear location of the bottom pad 24, and the tensioning device 72 of the seat back 30 is disposed at a bottom location of the back pad 34. In other embodiments, the support changers 42, 52 may be disposed at any suitable location of the seating row 10.

In the flat configuration, as shown in FIG. 7B, the tensioning device 72 tightens the straps 70 such that the straps 70 are taut and flat, forming a substantially flat upper surface 29 of the seat bottom 20 and/or a substantially flat forward surface 39 of the seat back 30. In the contour configuration, as shown in FIG. 7C, the tensioning device 72 at least partially loosens the straps 70 to have enough slack such that the bottom recessed area 44 forms in the upper surface 29 of the seat bottom 20 and/or the back recessed area 54 forms in the forward surface 39 of the seat back 30.

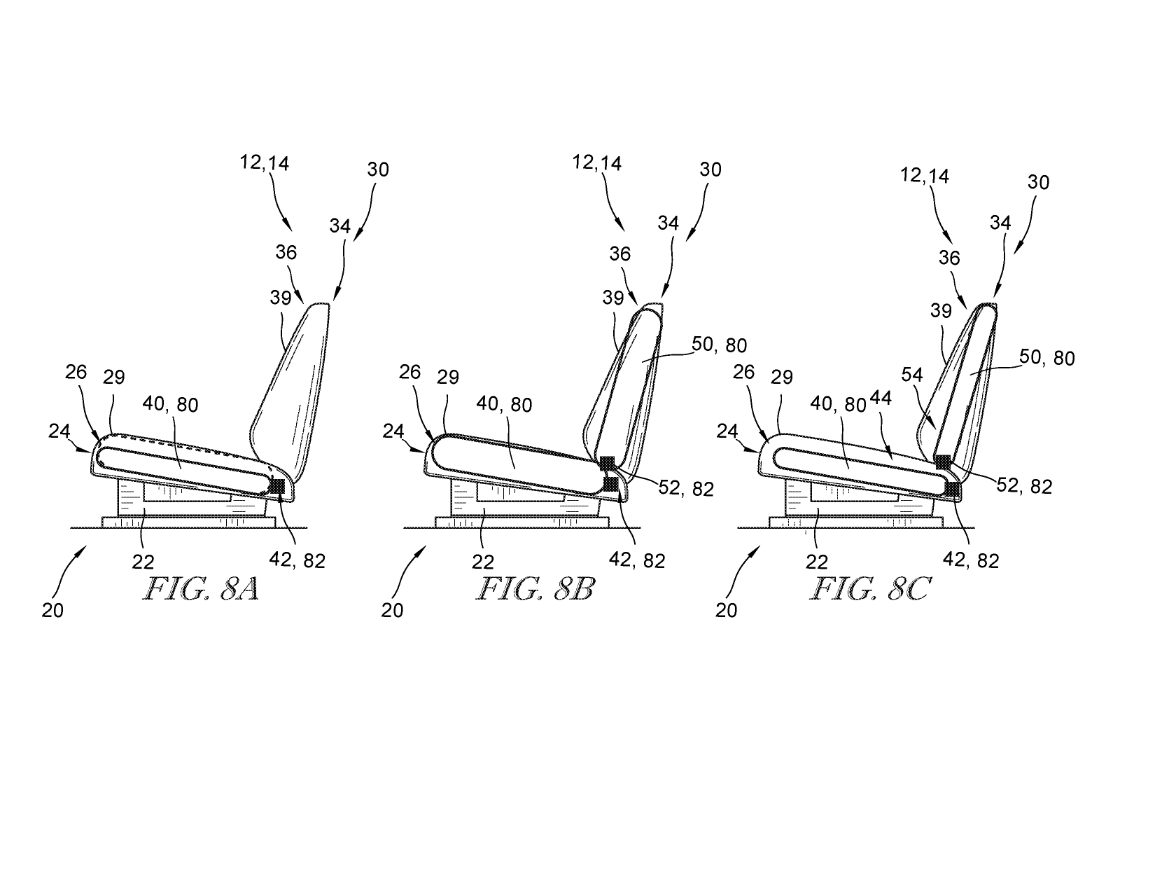

In some embodiments, at least one the supports 40, 50 is moveable between the raised and lowered positions by inflating or deflating the support 40, 50. For example, in some embodiments, as shown in FIGS. 8A-8C, at least one of the supports 40, 50 includes a bladder 80. In some embodiments, the support changer 42, 52 is a pneumatic device 82 operable to inflate or deflate the support 40, 50, such as a pump or other suitable device. In the illustrative embodiment, the back support 50 and the bottom support 40 of a respective seat 12, 14 each have a respective pneumatic device 82. In some embodiments, the back support 50 and the bottom support 40 of a respective seat 12, 14 utilize the same pneumatic device 82.

In the flat configuration, as shown in FIG. 8B, the pneumatic device 82 inflates the bladder 80 such that the bladder 80 forms a substantially flat upper surface 29 of the seat bottom 20 and/or a substantially flat forward surface 39 of the seat back 30. In the contour configuration, as shown in FIG. 8C, the pneumatic device 82 at least partially deflates the bladder 80 such that the bladder 80 is deformable enough to form the bottom recessed area 44 in the upper surface 29 of the seat bottom 20 and/or the back recessed area 54 in the forward surface 39 of the seat back 30.

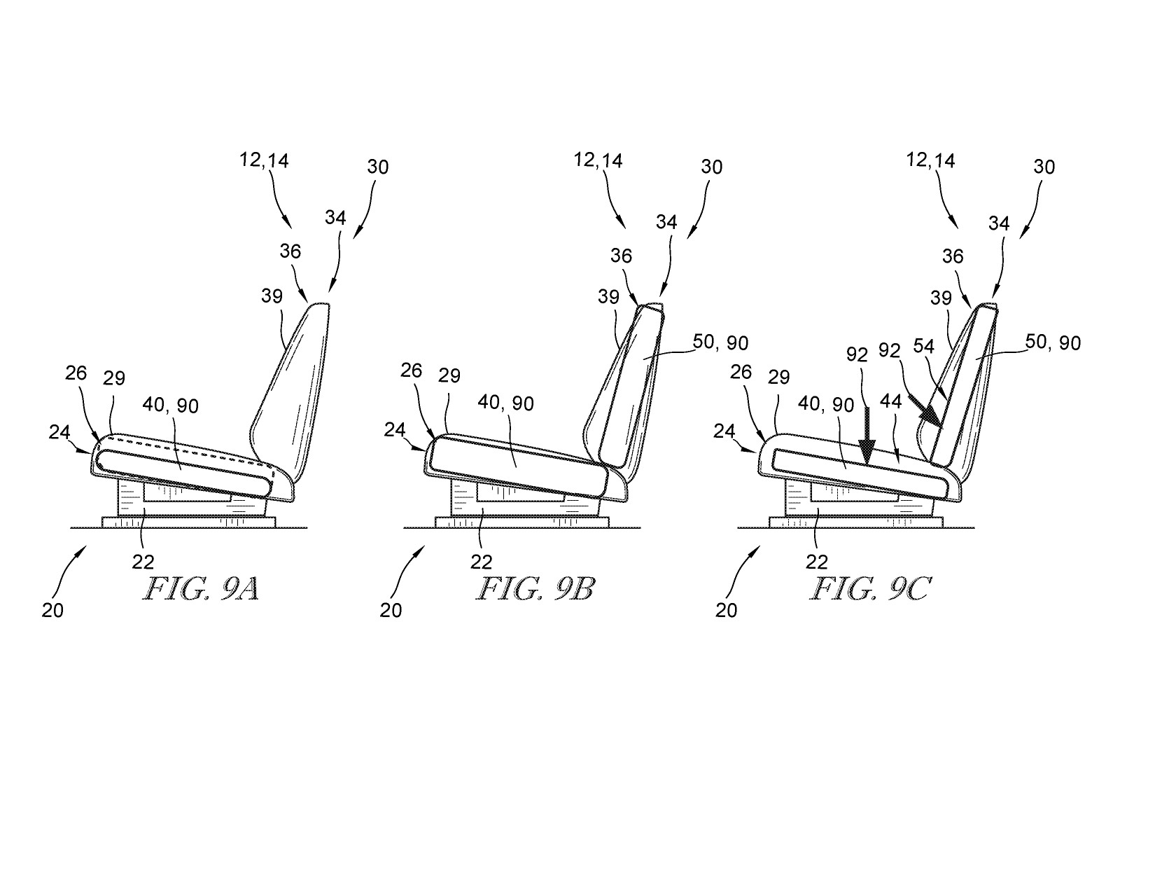

In some embodiments, at least one the supports 40, 50 is moveable between the raised and lowered positions by compressing the support 40, 50 with an external weight, such as the weight of the occupant and/or another object placed on the seating row 10. For example, in some embodiments, as shown in FIGS. 9A-9C, at least one of the supports 40, 50 includes a compressible and expandable material 90, such as a compressible foam. In some embodiments, the seat bottom 20 and/or the seat back 30 do not include a support changer 42, 52 or the support changer 42, 52 is the external weight 92 of the occupant and/or another object that compresses the support 40, 50.

In the flat configuration, as shown in FIG. 9B, the material 90 expands when no external weight 92 or occupant weight is applied to the material 90, such that the material 90 expands to provide a substantially flat upper surface 29 of the seat bottom 20 and/or a substantially flat forward surface 39 of the seat back 30. In the contour configuration, as shown in FIG. 9C, the material 90 is at least partially compressed by the external weight 92 such that the material 90 is compressed and/or deformed to form the bottom recessed area 44 in the upper surface 29 of the seat bottom 20 and/or the back recessed area 54 in the forward surface 39 of the seat back 30.

In the illustrative embodiments, the seating row 10 includes an inner bolster 60, a first outer bolster 62, and a second outer bolster 64. The inner bolster 60 is disposed between the first seat 12 and the second seat 14, extending along adjacent sides of the first and second seats 12, 14, as shown in FIGS. 1-3. In the illustrative embodiment, the first seat 12 and the second seat 14 each take up approximately half, or 50% of the seating row 10, with the inner bolster 60 disposed centrally in the seating row 10. In other embodiments, the first seat 12 and the second seat 14 may take up unequal portions of the seating row 10. For example, in other embodiments, the seating row may be split 60-40 between the first seat 12 and the second seat 14, with the inner bolster 60 between the two seats. In other embodiments, the seating row 10 may comprise a third seat and may be split 40-20-40 between the first seat 12, the second seat 14, and the third seat, with an inner bolster 60 between each seat.

The first outer bolster 62 is disposed along a side of the first seat 12, on an opposite side of the first seat 12 from the inner bolster 60. The second outer bolster 64 is disposed along a side of the second seat 14, on an opposite side of the second seat 12 from the inner bolster 60 and on an opposite outer end of the seating row 10 from the first outer bolder 62. In some embodiments, the inner bolster 60, the first outer bolster 62, and/or the second outer bolster 64 extend parallel to each other.

As shown in FIGS. 3 and 6, in the contour configuration, a portion of the upper surface 29 of the seat bottom 20 at the bottom recessed area 44 sits below a portion of the upper surface 29 of the seat bottom 20 at the bolsters 60, 62, 64. Additionally or alternatively, the recessed areas 44, 54 of the seats 12, 14 are disposed between a respective outer bolster 62, 64 and the inner bolster 60.

The following numbered clauses include embodiments that are contemplated and non-limiting:

Clause 1. A seating row for a vehicle, the seating row comprising a first seat and a second seat.

Clause 2. The seating row of clause 1, any other clause, or any combination of clauses, wherein the first seat is coupled to a floor of the vehicle.

Clause 3. The seating row of clause 2, any other clause, or any combination of clauses, wherein the second seat is coupled to the floor of the vehicle and to the first seat.

Clause 4. The seating row of clause 3, any other clause, or any combination of clauses, wherein each of the first seat and the second seat comprise a seat bottom and a seat back.

Clause 5. The seating row of clause 4, any other clause, or any combination of clauses, wherein the seat bottom includes a foundation coupled to the floor of the vehicle and a bottom pad coupled to the foundation, the bottom pad including a bottom cushion having a bottom support and a bottom support changer.

Clause 6. The seating row of clause 5, any other clause, or any combination of clauses, wherein the seat back is coupled to the seat bottom, the seat back including a headrest spaced above the seat bottom, a backrest located between the headrest and the seat bottom, and a back pad coupled to the backrest, the back pad including a back cushion having a back support and a back support changer.

Clause 7. The seating row of clause 6, any other clause, or any combination of clauses, wherein the seating row comprises an inner bolster disposed between the first seat and the second seat.

Clause 8. The seating row of clause 7, any other clause, or any combination of clauses, wherein the seating row comprises a first outer bolster disposed along a side of the first seat, opposite from the inner bolster.

Clause 9. The seating row of clause 8, any other clause, or any combination of clauses, wherein the seating row comprises a second outer bolster disposed along a side of the second seat, opposite from the inner bolster.

Clause 10. The seating row of clause 9, any other clause, or any combination of clauses, wherein the back support changer and the bottom support changer move the back support and the bottom support, respectively, between a raised position in a flat configuration and a lowered position in a contour configuration.

Clause 11. The seating row of clause 10, any other clause, or any combination of clauses, wherein, in the flat configuration, the bottom supports provide support to the seat bottom such that an upper surface of the seat bottom is flat.

Clause 12. The seating row of clause 10, any other clause, or any combination of clauses, wherein, in the flat configuration, the back support provides support to the seat back such that a forward surface of the seat back is flat.

Clause 13. The seating row of clause 10, any other clause, or any combination of clauses, wherein, in the contour configuration, the lowered position of at least one of the bottom support or the back support forms a recessed area in the seating row.

Clause 14. The seating row of clause 13, any other clause, or any combination of clauses, wherein, in the contour configuration, the inner bolster divides a respective recessed area of the first seat and the second seat.

Clause 15. The seating row of clause 10, any other clause, or any combination of clauses, wherein at least one of the bottom support or the back support comprises a bladder, the bladder pneumatically controlled to move between the raised position and the lowered position.

Clause 16. The seating row of clause 10, any other clause, or any combination of clauses, wherein at least one of the bottom support or the back support comprises at least one strap.

Clause 17. The seating row of clause 16, any other clause, or any combination of clauses, wherein the at least one strap is taut in the flat configuration and the at least one strap is slack in the contour configuration to allow a recessed area to be formed in the seating row.

Clause 18. The seating row of clause 16, any other clause, or any combination of clauses, 7, wherein the at least one strap extends from a rear portion of the seat bottom to a front portion of the seat bottom beneath an upper surface of the seat bottom.

Clause 19. The seating row of clause 16, any other clause, or any combination of clauses, wherein the at least one strap extends from a lower portion of the seat back to an upper portion of the seat back beneath a forward surface of the seat back.

Clause 20. The seating row of clause 16, any other clause, or any combination of clauses, wherein at least one of the bottom support changer or the back support changer comprises a tensioning device configured to loosen or tighten the plurality of straps.

Clause 21. The seating row of clause 20, any other clause, or any combination of clauses, wherein the tensioning device is disposed in a rear portion of the bottom cushion.

Clause 22. The seating row of clause 20, any other clause, or any combination of clauses, wherein the tensioning device is disposed in a lower portion of the back cushion.

Clause 23. The seating row of clause 10, any other clause, or any combination of clauses, wherein, in the contour configuration, a first portion of an upper surface of the seat bottom above the bottom support sits below a second portion of the upper surface of the seat bottom at the inner bolster.

Clause 24. The seating row of clause 10, any other clause, or any combination of clauses, wherein at least one of the bottom support or the back support comprises a compressible material.

Clause 25. The seating row of clause 24, any other clause, or any combination of clauses, wherein, the compressible material is at least partially expanded in the flat configuration when no external weight is applied to the seating row.

Clause 26. The seating row of clause 24, any other clause, or any combination of clauses, wherein, the compressible material is at least partially compressed in the contour configuration to form a recessed area when an external weight is applied to the seating row.

Clause 27. A seating row for a vehicle, the seating row comprising a first seat and a second seat.

Clause 28. The seating row of clause 27, any other clause, or any combination of clauses, wherein the first seat is coupled to a floor of the vehicle.

Clause 29. The seating row of clause 28, any other clause, or any combination of clauses, wherein the second seat is coupled to the floor of the vehicle and to the first seat.

Clause 30. The seating row of clause 29, any other clause, or any combination of clauses, wherein each of the first seat and the second seat comprise a seat bottom and a seat back.

Clause 31. The seating row of clause 30, any other clause, or any combination of clauses, wherein the seat bottom includes a foundation coupled to the floor of the vehicle and a bottom pad coupled to the foundation, the bottom pad including a bottom cushion having a bottom support and a bottom support changer.

Clause 32. The seating row of clause 31, any other clause, or any combination of clauses, wherein the seat back is coupled to the seat bottom.

Clause 33. The seating row of clause 32, any other clause, or any combination of clauses, wherein the seating row comprises an inner bolster disposed between the first seat and the second seat.

Clause 34. The seating row of clause 33, any other clause, or any combination of clauses, wherein the bottom support changer moves the bottom support between a raised position in a flat configuration and a lowered position in a contour configuration.

Clause 35. The seating row of clause 34, any other clause, or any combination of clauses, wherein, in the flat configuration, the bottom supports provide support to the seat bottom such that an upper surface of the seat bottom is flat, and, in the contour configuration, the lowered position of at least one of the bottom support or the back support forms a recessed area in the seating row.

Clause 36. A seating row for a vehicle, the seating row comprising a first row and a second row.

Clause 37. The seating row of clause 36, any other clause, or any combination of clauses, where in the first seat is coupled to a floor of the vehicle.

Clause 38. The seating row of clause 37, any other clause, or any combination of clauses, wherein the second seat is coupled to the floor of the vehicle and to the first seat.

Clause 39. The seating row of clause 38, any other clause, or any combination of clauses, wherein each of the first seat and the second seat comprises a seat bottom and a seat back.

Clause 40. The seating row of clause 39, any other clause, or any combination of clauses, wherein the seat bottom includes a foundation coupled to the floor of the vehicle and a bottom pad coupled to the foundation.

Clause 41. The seating row of clause 40, any other clause, or any combination of clauses, wherein the seat back is coupled to the seat bottom, the seat back including a headrest spaced above the seat bottom, a backrest located between the headrest and the seat bottom, and a back pad coupled to the backrest, the back pad including a back cushion having a back support and a back support changer.

Clause 42. The seating row of clause 41, any other clause, or any combination of clauses, wherein the seating row comprises an inner bolster disposed between the first seat and the second seat.

Clause 43. The seating row of clause 42, any other clause, or any combination of clauses, wherein the back support changer moves the back support between a raised position in a flat configuration and a lowered position in a contour configuration.

1. A seating row for a vehicle, the seating row comprising
a first seat coupled to a floor of the vehicle,
a second seat coupled to the floor of the vehicle and to the first seat, each of the first seat and the second seat comprising
a seat bottom including a foundation coupled to the floor of the vehicle and a bottom pad coupled to the foundation, the bottom pad including a bottom cushion having a bottom support and a bottom support changer, and
a seat back coupled to the seat bottom, the seat back including a headrest spaced above the seat bottom, a backrest located between the headrest and the seat bottom, and a back pad coupled to the backrest, the back pad including a back cushion having a back support and a back support changer,
an inner bolster disposed between the first seat and the second seat,
a first outer bolster disposed along a side of the first seat, opposite from the inner bolster, and
a second outer bolster disposed along a side of the second seat, opposite from the inner bolster,
wherein the back support changer and the bottom support changer move the back support and the bottom support, respectively, between a raised position in a flat configuration and a lowered position in a contour configuration.

2. The seating row of claim 1, wherein, in the flat configuration, the bottom supports provide support to the seat bottom such that an upper surface of the seat bottom is flat.

3. The seating row of claim 1, wherein, in the flat configuration, the back support provides support to the seat back such that a forward surface of the seat back is flat.

4. The seating row of claim 1, wherein, in the contour configuration, the lowered position of at least one of the bottom support or the back support forms a recessed area in the seating row.

5. The seating row of claim 4, wherein, in the contour configuration, the inner bolster divides a respective recessed area of the first seat and the second seat.

6. The seating row of claim 1, wherein at least one of the bottom support or the back support comprises a bladder, the bladder pneumatically controlled to move between the raised position and the lowered position.

7. The seating row of claim 1, wherein at least one of the bottom support or the back support comprises at least one strap.

8. The seating row of claim 7, wherein the at least one strap is taut in the flat configuration and the at least one strap is slack in the contour configuration to allow a recessed area to be formed in the seating row.

9. The seating row of claim 7, wherein the at least one strap extends from a rear portion of the seat bottom to a front portion of the seat bottom beneath an upper surface of the seat bottom.

10. The seating row of claim 7, wherein the at least one strap extends from a lower portion of the seat back to an upper portion of the seat back beneath a forward surface of the seat back.

11. The seating row of claim 7, wherein at least one of the bottom support changer or the back support changer comprises a tensioning device configured to loosen or tighten the plurality of straps.

12. The seating row of claim 11, wherein the tensioning device is disposed in a rear portion of the bottom cushion.

13. The seating row of claim 11, wherein the tensioning device is disposed in a lower portion of the back cushion.

14. The seating row of claim 1, wherein, in the contour configuration, a first portion of an upper surface of the seat bottom above the bottom support sits below a second portion of the upper surface of the seat bottom at the inner bolster.

15. The seating row of claim 1, wherein at least one of the bottom support or the back support comprises a compressible material.

16. The seating row of claim 15, wherein, the compressible material is at least partially expanded in the flat configuration when no external weight is applied to the seating row.

17. The seating row of claim 15, wherein, the compressible material is at least partially compressed in the contour configuration to form a recessed area when an external weight is applied to the seating row.

18. A seating row for a vehicle, the seating row comprising
a first seat coupled to a floor of the vehicle,
a second seat coupled to the floor of the vehicle and to the first seat, each of the first seat and the second seat comprising
a seat bottom including a foundation coupled to the floor of the vehicle and a bottom pad coupled to the foundation, the bottom pad including a bottom cushion having a bottom support and a bottom support changer, and
a seat back coupled to the seat bottom,
an inner bolster disposed between the first seat and the second seat,
wherein the bottom support changer moves the bottom support between a raised position in a flat configuration and a lowered position in a contour configuration.

19. The seating row of claim 18, wherein, in the flat configuration, the bottom supports provide support to the seat bottom such that an upper surface of the seat bottom is flat, and, in the contour configuration, the lowered position of at least one of the bottom support or the back support forms a recessed area in the seating row.

20. A seating row for a vehicle, the seating row comprising
a first seat coupled to a floor of the vehicle,
a second seat coupled to the floor of the vehicle and to the first seat, each of the first seat and the second seat comprising
a seat bottom including a foundation coupled to the floor of the vehicle and a bottom pad coupled to the foundation, and
a seat back coupled to the seat bottom, the seat back including a headrest spaced above the seat bottom, a backrest located between the headrest and the seat bottom, and a back pad coupled to the backrest, the back pad including a back cushion having a back support and a back support changer,
an inner bolster disposed between the first seat and the second seat,
wherein the back support changer moves the back support between a raised position in a flat configuration and a lowered position in a contour configuration.
